(19) United States
(12) Patent Application Publication
(10) Pub. No.: US 2026/0181428 A1
(43) Pub. Date: Jun. 25, 2026

(54) PRIORITIZING SERVICE RESTORATION FOR SHARED ACCESS TECHNOLOGIES

(71) Applicant: AT&T Intellectual Property I, L.P., Atlanta, GA (US)

(72) Inventors: Michael Meche, Plano, TX (US); Stewart Barker, Lucas, TX (US)

(21) Appl. No.: 18/988,881

(22) Filed: Dec. 19, 2024

(51) Int. Cl. H04W 24/04; H04W 48/02

(52) U.S. Cl. CPC H04W 24/04; H04W 48/02

(57) ABSTRACT

A method performed by a processing system including at least one processor includes detecting a failure of a shared access system that provides communications access to a plurality of users, automatically determining an order of priority for the plurality of users based on at least one of: a predefined priority, an existence of a service level agreement, a usage of the shared access system immediately prior to the failure, a plurality of network traffic patterns associated with the plurality of users, or a correlation with a real-time event, and taking an action to restore an access to the shared access system for the plurality of users, wherein the access is restored to the plurality of users according to the order of priority.

The present disclosure relates generally to wireless and wireline communications and relates more particularly to devices, non-transitory computer-readable media, and methods for prioritizing service restoration for shared access technologies.

### BACKGROUND

Shared access systems are used in wireless and wireline communications to allow the sharing of a single communication channel among multiple users. For instance, examples of shared access systems include passive optical networking (PON) systems, cellular (e.g., Third Generation Partnership Project (3GPP)) systems, wireless fidelity (WiFi) (e.g., Institute of Electrical and Electronics Engineers (IEEE)) systems, data over cable service interface specification (DOCSIS) systems, low Earth orbit (LEO) satellite systems, multimedia over coaxial alliance (MOCA) systems, and other systems. Shared access systems may utilize technologies including time division multiple access (TDMA), orthogonal frequency division multiple access (OFDMA), frequency division multiple access (FDMA), carrier sense multiple access (CSMA), and code division multiple access (CDMA), among other technologies.

### SUMMARY

In one example, the present disclosure describes a device, computer-readable medium, and method for prioritizing service restoration for shared access technologies. For instance, in one example, a method performed by a processing system including at least one processor includes detecting a failure of a shared access system that provides communications access to a plurality of users, automatically determining an order of priority for the plurality of users based on at least one of: a predefined priority, an existence of a service level agreement, a usage of the shared access system immediately prior to the failure, a plurality of network traffic patterns associated with the plurality of users, or a correlation with a real-time event, and taking an action to restore an access to the shared access system for the plurality of users, wherein the access is restored to the plurality of users according to the order of priority.

In another example, a non-transitory computer-readable medium stores instructions which, when executed by a processor, cause the processor to perform operations. The operations include detecting a failure of a shared access system that provides communications access to a plurality of users, automatically determining an order of priority for the plurality of users based on at least one of: a predefined priority, an existence of a service level agreement, a usage of the shared access system immediately prior to the failure, a plurality of network traffic patterns associated with the plurality of users, or a correlation with a real-time event, and taking an action to restore an access to the shared access system for the plurality of users, wherein the access is restored to the plurality of users according to the order of priority.

In another example, a device includes a processor and a computer-readable medium storing instructions which, when executed by the processor, cause the processor to perform operations. The operations include detecting a failure of a shared access system that provides communications access to a plurality of users, automatically determining an order of priority for the plurality of users based on at least one of: a predefined priority, an existence of a service level agreement, a usage of the shared access system immediately prior to the failure, a plurality of network traffic patterns associated with the plurality of users, or a correlation with a real-time event, and taking an action to restore an access to the shared access system for the plurality of users, wherein the access is restored to the plurality of users according to the order of priority.

### BRIEF DESCRIPTION OF THE DRAWINGS

The teachings of the present disclosure can be readily understood by considering the following detailed description in conjunction with the accompanying drawings, in which:

FIG. 1 illustrates an example shared access system in which examples of the present disclosure may operate;

FIG. 2 illustrates a flowchart of an example method for prioritizing service restoration for shared access technologies, in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure prioritizes service restoration for shared access technologies. As discussed above, shared access systems are used in wireless and wireline communications to allow the sharing of a single communication channel among multiple users. For instance, examples of shared access systems include PON systems, cellular (e.g., 3GPP) systems, WiFi (e.g., IEEE) systems, DOCSIS systems, LEO satellite systems, MOCA systems, and other systems. Shared access systems may utilize technologies including TDMA, OFDMA, FDMA, CSMA, and CDMA, among other technologies.

Shared access systems may experience network-wide or geographically limited failures (disruptions to service) for a variety of reasons, including power disruptions, fiber cuts, equipment failures, equipment reboots, and the like. Following a network failure, restoration of service to users of a shared access system (who may number in the thousands) tends to vary. For instance, service to some users may be restored in as little as ten minutes, while other users may wait up to an hour to see their service restored. While a more lengthy service disruption may be an inconvenience for some users (e.g., users who are streaming video at home), such a disruption could have life-threatening consequences for other users (e.g., first responders who are trying to provide services people experiencing emergencies). Currently, however, service restoration procedures fail to differentiate between users based on priority, and so service tends to be restored to users in an essentially random manner, or at least without any insight from the operator of the shared access system.

Examples of the present disclosure restore service to shared access system users by prioritizing selected users. More specifically, following a failure of the shared access system, users who have been selected for prioritized restoration may see their service restored sooner than other users who have not been selected for prioritized restoration (or who have been identified as being of lower priority than the selected users). This approach allows an operator of the shared access system to ensure that resources are allocated to restore access to critical services as soon as possible.

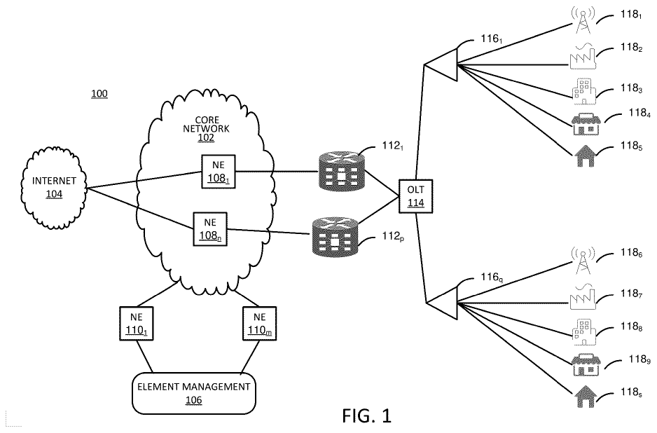

In some examples, prioritization of users can be performed manually during the service provisioning process (e.g., by a system administrator), and the prioritization that is configured will then be implemented during later service restoration. In another example, machine learning techniques may be utilized to dynamically determine an order of priority for restoring service to various users in real time (e.g., at a time of failure). In the latter case, time shifting may be used to align with the readiness of the shared access system platform. Thus, examples of the present disclosure will enhance the efficiency and reliability of shared access systems by ensuring prioritized restoration of service for users of critical services. Within this context, a “user” may be understood to be either an individual (e.g., human) user of a shared access system, a group of users (e.g., a family or enterprise) of the shared access system, an infrastructure element of the shared access system (e.g., a cellular base station), or a service (e.g., an emergency response service, such as fire, police, or paramedics, a public notification system such as a national and/or local emergency broadcast system, a missing persons notification system, a child abduction emergency alert system, a network slice that is dedicated for emergency response services, or the like) that is provided via the shared access system. These and other aspects of the present disclosure are discussed in greater detail in connection with FIGS. 1-3, below.

FIG. 1 illustrates an example shared access system 100 in which examples of the present disclosure may operate. The example shared access system 100 of FIG. 1 is illustrated as comprising a passive optical network (PON). However, a PON is just one example of a shared access system that may be adapted for prioritized service restoration according to examples of the present disclosure. In other examples, the shared access system 100 could be another type of communication service provider network, such as a cellular network (e.g., a Fifth Generation (5G) network, a 4G/Long Term Evolution (LTE)/5G hybrid network, or the like), a service network, and an Internet Protocol (IP) Multimedia Subsystem (IMS) network, a WiFi (e.g., IEEE) system, a DOCSIS system, a LEO satellite system, a MOCA system, or another system.

In one example, the shared access system 100 comprises a core network 102 connected to the Internet 104 and to an element management system 106. In one example, the core network 102 provides various functions that support communications services in the PON environment. To this end, the core network 102 may include a plurality of network elements (NEs) 108₁-108ₙ (hereinafter individually referred to as an “NE 108” or collectively referred to as “NEs 108”) for transmitting signals from the Internet 104 to end users 118₁-118ₛ (hereinafter individually referred to as an “end user 118” or collectively referred to as “end users 118”). The NEs 108 may support functions including user authentication, registration management, connection management, endpoint device reachability management, endpoint device IP address management, routing and forwarding of data packets, quality of service (QoS) enforcement, traffic shaping, packet inspection, selection of network slices to support end users 118, maintenance of subscription-related information (e.g., user profiles), access between the core network 102 and the Internet 104, and other functions.

A “network slice” in this context may comprise a set of network components, such as a set of NEs 108, routers 112₁-112ₚ (hereinafter individually referred to as a “router 112” or collectively referred to as “routers 112”), splitters 116₁-116_{q} hereinafter individually referred to as a “splitter 116” or collectively referred to as “splitters 116”), and so forth that may be arranged into different network slices which may logically be considered to be separate networks or shared access systems. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

Communications from the Internet 104 may be routed through the core network 102 (e.g., via NEs 108) to one or more metro routers 112, which may in turn route the communications to an optical line terminal (OLT) 114. The OLT 114 may be part of a central office or head end of the shared access system 100. A central office comprises a hub or centrally located point in a PON at which a conglomerate signal is distributed to optical nodes (e.g., in neighborhoods or premises locations). The conglomerate signal may carry voice, data, and/or video services to the end users 118.

The OLT 114 may send the communications further downstream as traffic to one or more of the splitters 116, where each splitter 116 receives a single stream from the OLT 114. Each splitter 116 may comprise an unpowered fiber optic splitter and may comprise a portion of a primary flexibility point (PFP) cabinet or enclosure. In one example, the each splitter 116 is a 1:N optical splitter that receives the conglomerate signal that is output by the OLT 114. Each splitter 116 separates the single conglomerate signal into up to N individual signals of different wavelengths (e.g., one wavelength or range of wavelengths per individual signal) for distribution to the end users 118.

The end users 118 of the shared access system 100 may comprise a plurality of different types of end users, including cellular backhaul systems and equipment, industrial users, enterprise users, small business users, individual or home users, services, and the like.

In one example, the shared access system 100 may further comprise an element management system 106 which may connect to the core network 102 via one or more network elements 110₁-110ₘ (hereinafter individually referred to as a “network element 110” or collectively referred to as “network elements 110”). The element management system 106 may be configured to perform operations of the present disclosure relating to prioritizing service restoration for shared access technologies.

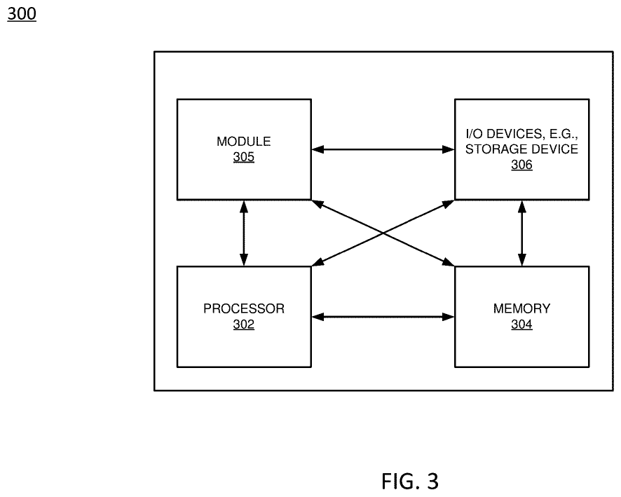

In one example, the element management system 106 may comprise all or a portion of a computing system, such as computing system 300 depicted in FIG. 3, and may be configured to perform steps, functions, and/or operations in connection with examples of the present disclosure for prioritizing service restoration for shared access technologies. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In accordance with the present disclosure, when the shared access system 100 experiences a failure (due to, for example, a power disruption, a fiber cut, an equipment failure, an equipment reboot, or the like), the element management system 106 may collect data relating to the circumstances of the failure, such as the time at which the failure occurred (e.g., peak versus off-peak usage time), usage of the shared access system 100 at the time at which the failure occurred (e.g., which end users 118 were actively using the shared access system 100 at the time at which the failure occurred), and any real-time events (e.g., natural disasters, emergencies, scheduled events, or the like) that are co-occurring with the failure. Data about the time and usage of the shared access system 100 may be obtained from one or more sensors which may be distributed throughout the shared access system 100. Data about the real-time events may be obtained from external data sources such as the Internet 104, sensors connected to the shared access system 100, and other sources.

The element management system 106 may also collect data relating to the relative priorities of different end users 118. The data may include priority information defined by an administrator of the shared access system 100, service level agreements (SLAs) that have been defined for any of the end users 118, and usage patterns and activity of the end users 118. Priority information defined by an administrator may be obtained from administrators systems and records, such as profiles for the end users 118. Data about usage patterns may be obtained from one or more sensors which may be distributed throughout the shared access system 100.

In one example, the element management system 106 may utilize the data relating to the circumstances of the failure and the data relating to the relative priorities of the end users 118 to determine an order of priority for the end users 118, where the order of priority specifies an order in which access to the shared access system 100 is to be restored to the end users 118. The order or priority may vary depending upon the exact circumstances of the failure. For instance, while data relating to the relative priorities of the end users 118 may provide a default order of priority, the circumstances of the failure may motivate deviations from this default order or priority. For instance, end users 118 who have SLAs may be given priority over end users 118 who do not have SLAs in most cases. However, if an end user 118 who does not have an SLA was actively using the shared access system 100 at the time of the failure, while an end user who has an SLA was not actively using the shared access system 100 at the time of failure, then the end user 118 who does not have the SLA may be given priority in this case. In another example, if the failure occurred at the same time as an emergency event (e.g., a natural disaster, a traffic accident, a building fire, or the like), then end users 118 who are located in physical proximity to the site of the emergency event may be given priority over other end users 118, regardless of the existence of SLAs or of active usage by the end users 118. In some examples, emergency services may always be given priority over all other end users 118.

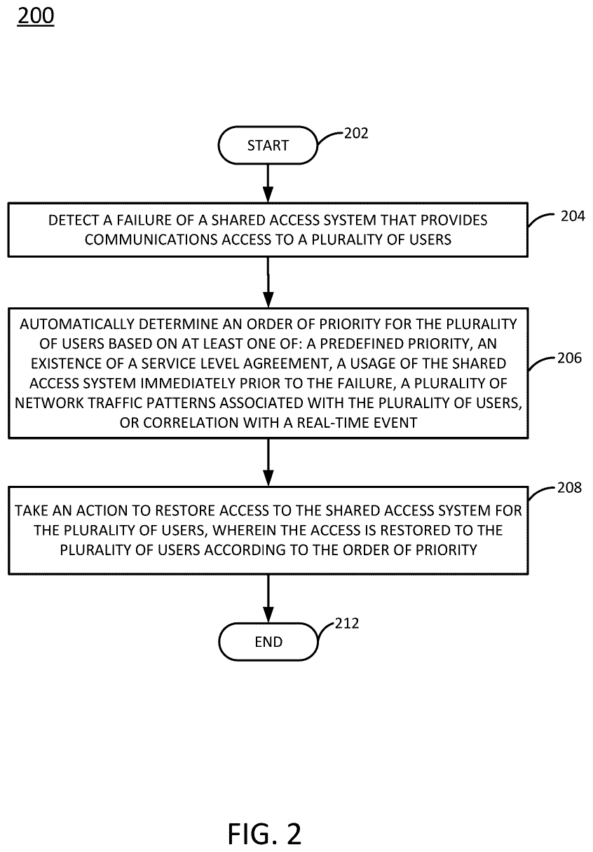

It should be noted that examples of the present disclosure as described herein primarily in connection with steps, functions, and/or operations that are performed by an element management system. For instance, FIG. 2 illustrates a flowchart of an example method that may be performed by an element management system. However, in other, further, and different examples, various steps, functions, and/or operations as described in connection with FIG. 2, or as described elsewhere herein, may alternatively or additionally be performed by one or more other components. For instance, various steps, functions, and/or operations may alternatively or additionally be performed by an application server in the core network 102 or by another device.

The foregoing description of the shared access system 100 is provided as an illustrative example only. In other words, the example of shared access system 100 is merely illustrative of one network configuration that is suitable for implementing examples of the present disclosure. As such, other logical and/or physical arrangements for the shared access system 100 may be implemented in accordance with the present disclosure. For example, the shared access system 100 may be expanded to include additional networks, such as network operations center (NOC) networks, additional access networks, and so forth. The shared access system 100 may also be expanded to include additional network elements such as border elements, routers, switches, policy servers, security devices, gateways, a content distribution network (CDN) and the like, without altering the scope of the present disclosure. In addition, shared access system 100 may be altered to omit various elements, substitute elements for devices that perform the same or similar functions, combine elements that are illustrated as separate devices, and/or implement network elements as functions that are spread across several devices that operate collectively as the respective network elements. Thus, these and other modifications are all contemplated within the scope of the present disclosure.

To further aid in understanding the present disclosure, FIG. 2 illustrates a flowchart of an example method 200 for prioritizing service restoration for shared access technologies, in accordance with the present disclosure. In one example, the method 200 may be performed by an element management system that is configured to determine an order in which access to shared access technologies should be restored to users following a service disruption, such as the element management system 106 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may detect a failure of a shared access system that provides communications access to a plurality of users. In one example, the shared access system may comprise one or more of: a PON system, a cellular (e.g., 3GPP) system, a WiFi (e.g., IEEE) system, a DOCSIS system, a LEO satellite system, a MOCA system, and or another type of shared access system. The shared access systems may utilize technologies including TDMA, OFDMA, FDMA, CSMA, and CDMA, among other technologies. The shared access system may provide access to wireless communications, wireline communications, or both wireless and wireline communications.

The plurality of users of the shared access system may include a variety of different types of users. For instance, users of the shared access system may include individual (e.g., human) users, groups of users (e.g., families or enterprises), small businesses, network infrastructure elements (e.g., cellular base stations, routers, and the like), or services (e.g., emergency response services, such as fire, police, or paramedics, public notification systems such as national and/or local emergency broadcast systems, missing persons notification systems, child abduction emergency alert systems, or the like, or a network slice that is dedicated for emergency response services).

The failure of the shared access system may comprise a network-wide failure or geographically limited failure, and may be attributed to one or more causes including a power disruption, a fiber cut, an equipment failure, an equipment reboot, or the like. The processing system may detect the failure in any one or more of a variety of ways. For instance, in one example, the processing system may detect the failure through an inability of the processing system to access a particular device or service via the shared access system (e.g., a router, a cellular base station, or another network element fails to respond to a query from the processing system or to send a signal (e.g., a heartbeat signal) to the processing system at a pre-designated time). In another example, the processing system may detect the failure through the receipt of an alert from a ticketing system that monitors the shared access system for failures. For instance, the ticketing system may receive, process, and attempt to resolve tickets submitted by users of the shared access system who have reported difficulties accessing devices or services.

In step 206, the processing system may automatically determine an order of priority for the plurality of users based on at least one of: a predefined priority, an existence of a service level agreement, a usage of the shared access system immediately prior to the failure, a plurality of network traffic patterns associated with the plurality of users, or a correlation with a real-time event.

In one example, the order of priority refers to an order in which service should be restored to the plurality of users after a failure of the shared access system (e.g., which users of the plurality of users should have their service restored soonest versus which users of the plurality of users may be able to wait longer for restoration of service). In one example, the order of priority may be based on any one of the factors described above, or on any combination of two or more of the factors described above (as well as potentially other factors). When the order of priority is based on a combination of factors, those factors may be weighted according to weights provided by the administrator of the shared access system. For instance, the administrator may specify that certain factors (e.g., predefined priority, or occurrence of emergency events) should be given more weight in determining the order of priority than other factors (e.g., usage of the shared access system immediately prior to the failure, or network traffic patterns).

Moreover, the order of priority may vary based upon the nature of the failure, the timing of the failure (e.g., night time versus daytime, weekday versus weekend, holiday versus non-holiday, etc.), events that are co-occurring with the failure (e.g., natural disasters, emergencies, planned events such as elections or medical services clinics, and the like), and other circumstances. Thus, the order of priority for one failure may be different from the order of priority determined for another failure of the same shared access system and for the same plurality of users (e.g., give or take a number of users that may have left the shared access system or recently joined the shared access system).

In one example, a predefined priority may be defined by an administrator of the shared access system. For instance, the administrator may specify that service should first be restored to network elements of the shared access system infrastructure, then to emergency services, then to industrial users, then to enterprise users, then to small businesses, and then to individual users. This order of priority may ensure that any disruption to the access of emergency services, which may be needed without warning and at any time, is minimized to the greatest extent possible. This order of priority may also ensure a quickest overall restoration of service to all users of the plurality of users, since restoration of service to network elements may be necessary before service can be restored to other users.

In another example, users for whom service level agreements (SLAs) have been defined may be ranked higher in the order of priority than users for whom no SLA has been defined. SLAs, if defined, may be specified in a plurality of profiles for the plurality of users. In a further example, users for whom SLAs have been defined may be ranked further based on different levels of service that have been defined in the SLAs. For instance, SLAs for a first subset of the plurality of users may specify that service should be restored within twenty minutes of a failure, while SLAs for a second subset of the plurality of users may specify that service should be restored within thirty minutes of a failure, and so on. This order of priority would minimize the likelihood of the operator of the shared access system violating any existing SLAs in the process of restoring service, which could be costly to the operator in terms of financial penalties, lost business, or the like.

In another example, users from whom a greater amount or percentage of revenue is derived (e.g., enterprise users) may be ranked higher in the order of priority than users from whom a lesser amount or percentage of revenue is derived (e.g., individual users). This order of priority would minimize the likelihood of the operator of the shared access system losing the most financially valuable users of the shared access system.

In another example, users who were actively using the shared access system immediately prior to (e.g., at the time of) the failure may be ranked higher in the order of priority than users who were not actively using the shared access system immediately prior to (e.g., at the time of) the failure. Whether a user was actively using the shared access system at the time of the failure may be determined based on real time monitoring data from one or more sensors that monitor usage of resources of the shared access system. Alternatively, three or more windows of time may be defined, and each user of the plurality of users may be associated with one window of the three or more windows based on the time at which the user last used the shared access system (e.g., a user who last used the shared access system six hours ago may be associated with a window that covers a time period from five to ten hours ago). The plurality of users may then be ranked in order beginning with the users whose window of time is closest in time to the time of failure and ending with the users whose window of time is furthest in time from the time of failure. This order of priority would ensure that service is restored most quickly to the users who were actively using the shared access system at the time of failure. Users who were not actively using the shared access system at the time of failure may have less need for quicker restoration of service, and in fact may not even notice any effects resulting from the disruption of service.

In another example, the order or priority may be determined based on historical network traffic patterns associated with the plurality of users. For instance, users who are historically most active in the shared access system during a time of the failure may be ranked higher in the order of priority than users who are historically less active in the shared access system during a time of the failure. Thus, if the failure occurred after 10:00 PM local time, users who tend to use the shared access system more at night may be ranked higher in the order of priority than users who tend to use the shared access system in the morning or afternoon. This order of priority would ensure that service is restored most quickly to the users who are most likely to use the shared access system at or just after the time of failure. Users who are unlikely to be actively using the shared access system at or just after the time of failure may have less need for quicker restoration of service, and in fact may not even notice any effects resulting from the disruption of service.

Alternatively, users whose average traffic volume per-day is above a first threshold volume may be ranked higher in the order of priority than users whose average traffic volume per-day is below the first threshold volume but above a second threshold volume, and so on. There are many ways in which the plurality of users may be classified based on network traffic patterns. For instance, other historical network traffic patterns could include median, maximum, or minimum traffic volume, typical senders or receivers of the network traffic, average, media, maximum, or minimum throughput or data bitrate, or other network traffic patterns. In a further example, the network traffic patterns on which the order of priority is based could be predicted network traffic patterns for a specific window of time (e.g., a window of time over which access to the shared access system is to be restored), where the predicted network traffic patterns may be predicted (e.g., using machine learning) based on historical network traffic patterns.

In a further example, the order of priority may be determined based on correlation with a real-time event (whose occurrence may be determined based on data obtained from real-time news sources). For instance, if the real-time news sources indicate that a large building is currently on fire, then users who are associated with fire response (e.g., fire stations, firefighters, paramedics, hazardous materials mitigation, and the like) may be ranked higher in the order of priority than other types of emergency services (e.g., police, search and rescue, missing persons alert systems, and the like), which in turn may be ranked higher in the order of priority than users who are not associated with any type of emergency services. This order of priority may ensure that users whose assistance may be required to respond to the real-time event experience the shortest possible disruption of service.

In one example, the order of priority may be determined based on predefined rules that are specified by an administrator of the shared access system, where the predefined rules define how to balance the factors described above in order to determine the order of priority for the plurality of users.

In another example, the order of priority may be determined by executing a machine learning model that is trained to take the factors described above as inputs and to generate as an output the order of priority (e.g., a ranked list defining the order on which service is to be restored to all users of the plurality of users). In one example, the machine learning model may be trained using a set of training data that includes data associated with historical failures of the shared access system. The set of training data may be annotated with metadata or labels that indicate how the administrator believes the plurality of users should have been prioritized for each of the historical failures. The machine learning model may learn patterns from the set of training data that allow the machine learning model to best prioritize the plurality of users for any new or yet-to-occur failure of the shared access system. In one example, the machine learning model may comprise one or more of: a generative artificial intelligence model (e.g., a large language model, a small language model, or the like), a support vector machine, a linear regression model, a random forest model, a neural network (e.g., a convolutional neural network, a deep convolutional neural network, or the like), a Bayesian model, or another type of machine learning model.

It should be noted that where the order of priority is determined through machine learning, there may be an option for a system administrator to review and manually override or alter the order of priority generated by the machine learning model. In one example, the alteration may be made by the system administrator before any action is taken to restore access to the shared access system (e.g., as described in greater detail in connection with step 208). Any overrides or alterations made by the administrator to the machine learning-generated order of priority may be provided to the machine learning model as further training data to improve orders of priority that are generated by the machine learning model in the future.

In step 208, the processing system may take an action to restore an access to the shared access system for the plurality of users, wherein the access is restored to the plurality of users according to the order of priority. In one example, the action to restore the access may involve rebooting a network element, such as a cellular base station, a router, or the like. For instance, if the failure was caused by a loss of power, many network elements may need to be rebooted and may need to reestablish connections to other network elements once power is restored. In one example, the processing system may indicate that any network elements that serve physical locations (e.g., cells) in which high-priority users (e.g., users who are ranked in the top x percent in the order of priority) are located should be rebooted first.

In another example, the action taken in step 210 may involve deploying a software update or replacing hardware. The software update or hardware replacement may be first performed in a physical location in which high-priority users are located. For instance, user endpoint devices or customer premises equipment (e.g., an optical network unit or optical network terminal) of the high priority users may be replaced or updated before the user endpoint devices or customer premises equipment of other users are replaced or updated.

In a further example, taking the action may include sending one or more out-of-band communications to the plurality of users to provide updates on the failure and the efforts to restore access to the shared access system. For instance, the out-of-band communications may provide the plurality of users with estimates as to the times at which the plurality of users can expect to have access to the shared access system restored. The method 200 may end in step 212.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

Thus, examples of the present disclosure restore service to shared access system users by prioritizing selected users. More specifically, following a failure of the shared access system, users who have been selected for prioritized restoration may see their service restored sooner than other users who have not been selected for prioritized restoration (or who have been identified as being of lower priority than the selected users). This approach allows an operator of the shared access system to ensure that resources are allocated to restore access to critical services as soon as possible.

It should be noted that any order of priority determined for a given shared access system may vary on a case-by-case basis. That is, depending upon the circumstances of a given failure, the order of priority determined for service restoration may be different from the order or priority determined for a different failure of the same shared access system. For instance, in most cases, an order of priority may prioritize users with SLAs and/or users who subscribe to a “premium” level of service over users who do not have SLAs or who subscribe to a “basic” level of service. However, if the shared access system experiences a failure during a time at which most users with SLAs or premium subscriptions are not actively using the shared access system (e.g., an off-peak time), but users without SLAs or with basic subscriptions are actively using the shared access system, then in this case the order of priority may favor the users who were actively using the shared access system at the time of failure, even if those users do not have SLAs or subscribe to a premium level of service. Thus, in this sense, the method 200 is adaptive to the specific circumstances of each failure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, an application server or an element management system of a shared access system (such as might be used to perform the method 200) could be implemented as illustrated in FIG. 3.

As depicted in FIG. 3, the system 300 comprises a hardware processor element 302, a memory 304, a module 305 for prioritizing service restoration for shared access technologies, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for prioritizing service restoration for shared access technologies may include circuitry and/or logic for balancing a combination of factors to determine an order in which to restore access to a shared access system to end users following a failure. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for prioritizing service restoration for shared access technologies (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for prioritizing service restoration for shared access technologies (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
detecting, by a processing system including at least one processor, a failure of a shared access system that provides communications access to a plurality of users;
automatically determining, by the processing system, an order of priority for the plurality of users based on at least one of: a predefined priority, an existence of a service level agreement, a usage of the shared access system immediately prior to the failure, a plurality of network traffic patterns associated with the plurality of users, or a correlation with a real-time event; and
taking, by the processing system, an action to restore an access to the shared access system for the plurality of users, wherein the access is restored to the plurality of users according to the order of priority.

2. The method of claim 1, wherein the shared access system comprises at least one of: a passive optical networking system, a cellular system, a wireless fidelity system, a data over cable service interface specification system, a low earth orbit satellite system, or a multimedia over coaxial alliance system.

3. The method of claim 1, wherein the plurality of users includes at least one of: an individual user, a groups of user, a small business, a network infrastructure element, or a service provided via the shared access system.

4. The method of claim 1, wherein the order of priority defines an order in which the access to the shared access system is to be restored to the plurality of users after the failure of the shared access system.

5. The method of claim 1, wherein weights are applied to the at least one of: the predefined priority, the existence of a service level agreement, the usage of the shared access system immediately prior to the failure, the plurality of network traffic patterns associated with the plurality of users, or the correlation with the real-time event.

6. The method of claim 1, wherein the order of priority varies based upon at least one of: a nature of the failure, a timing of the failure, or a co-occurrence of the real-time event with the failure.

7. The method of claim 6, wherein the order of priority that is determined is different from an earlier order of priority that was determined for the shared access system and the plurality of users following an earlier failure of the shared access system.

8. The method of claim 1, wherein the predefined priority is defined by an administrator of the shared access system.

9. The method of claim 1, wherein the order of priority ranks users of the plurality of users for whom service level agreements have been defined higher than users of the plurality of users for whom no service level agreement has been defined.

10. The method of claim 1, wherein the order of priority ranks users of the plurality of users from whom an operator of the shared access system derives a greater amount of revenue higher than users of the plurality of users from whom the operator of the shared access system derives a lesser amount of revenue.

11. The method of claim 1, wherein the order of priority ranks users of the plurality of users who were actively using the shared access system immediately prior to the failure higher than users of the plurality of users who were not actively using the shared access system immediately prior to the failure.

12. The method of claim 1, wherein the order of priority ranks users of the plurality of users who are historically most active in the shared access system during a time of the failure higher than users of the plurality of users who are historically less active in the shared access system during the time of the failure.

13. The method of claim 1, wherein the order of priority ranks users of the plurality of users who are emergency responders higher than users of the plurality of users who are not emergency responders.

14. The method of claim 1, wherein the real-time event comprises an emergency, and the order of priority ranks users of the plurality of users who are in closer physical proximity to a location of the emergency higher than users of the plurality of users who are physically further away from the location of the emergency.

15. The method of claim 1, wherein the automatically determining comprises executing a machine learning model that takes as an input the at least one of: the predefined priority, the existence of the service level agreement, the usage of the shared access system immediately prior to the failure, the plurality of network traffic patterns associated with the plurality of users, or the correlation with a real-time event and generates as an output the order of priority.

16. The method of claim 15, wherein an alteration to the order of priority is made by an administrator of the shared access system prior to the action being taken.

17. The method of claim 16, wherein the alteration is provided to the machine learning model as training data.

18. The method of claim 1, wherein the action comprises sending a plurality of out-of-band communications to the plurality of users to provide an update on the failure and an effort to restore the access to the shared access system.

19. A non-transitory computer-readable medium storing instructions which, when executed by a processing system including at least one processor, cause the processing system to perform operations, the operations comprising:
detecting a failure of a shared access system that provides communications access to a plurality of users;
automatically determining an order of priority for the plurality of users based on at least one of: a predefined priority, an existence of a service level agreement, a usage of the shared access system immediately prior to the failure, a plurality of network traffic patterns associated with the plurality of users, or a correlation with a real-time event; and
taking an action to restore an access to the shared access system for the plurality of users, wherein the access is restored to the plurality of users according to the order of priority.

20. A device comprising:
a processing system including at least one processor; and
a computer-readable medium storing instructions which, when executed by the processing system, cause the processing system to perform operations, the operations comprising:
detecting a failure of a shared access system that provides communications access to a plurality of users;
automatically determining an order of priority for the plurality of users based on at least one of: a predefined priority, an existence of a service level agreement, a usage of the shared access system immediately prior to the failure, a plurality of network traffic patterns associated with the plurality of users, or a correlation with a real-time event; and
taking an action to restore an access to the shared access system for the plurality of users, wherein the access is restored to the plurality of users according to the order of priority.
